(19) United States
(12) Patent Application Publication
(10) Pub. No.: US 2016/0091926 A1
(43) Pub. Date: Mar. 31, 2016

(54) DOCKING APPARATUS AND SYSTEMS FOR MOBILE COMPUTING DEVICES

(71) Applicant: Jeremy Saxton, Draper, UT (US)

(72) Inventor: Jeremy Saxton, Draper, UT (US)

(73) Assignee: Quell & Company, LLC, Draper, UT (US)

(21) Appl. No.: 14/503,036

(22) Filed: Sep. 30, 2014

(51) Int. Cl. G06F 1/16; G06F 13/40

(52) U.S. Cl. CPC G06F 1/1632; G06F 13/4081

(57) ABSTRACT

Disclosures are presented for systems and apparatus for docking a mobile computing device for display and for coupling it with a cable for purposes of charging and/or syncing. Such teachings may allow a user to reel the cable around a spool, couple the mobile computing device with the cable, decouple the mobile computing device, and/or swivel the mobile computer in its stand with relative ease, such as with a single hand, through the use of micro-suction cups. Disclosures are made about how the cable may be threaded through and secured by such systems and apparatus. Additional disclosures teach approaches for standing the mobile computer in its dock and for making accommodating adjustments to such a stand to provide adaptability across a range of mobile computer configurations, among other disclosures.

### FIELD OF THE INVENTION

This invention relates to the storage and maintenance of mobile computers and, more particularly, to docking systems for mobile computing devices.

### BACKGROUND OF THE INVENTION

Various mobile devices, such as smartphones, tablets, and the like have become ubiquitous in contemporary life. Although such devices are often configured for wireless communication, they remain intermittently tethered to a cable for daily, or nearly daily, charging. Additionally, it is often useful to sync such mobile devices with other computing devices via such a cable. Unfortunately, the cables required to charge and/or sync mobile devices are known for being a nuisance, particularly in the presence of other cables with which they may tangle.

Additionally, it is often desirable to stow a mobile device during charging and/or syncing where it can easily be viewed, interacted with, and or adjusted. This is also often the case where charging or syncing is not required, such as when a user is following instructions displayed on the device. A mobile-device stand providing interactive functionality should echo the mobility provided by the devices while being able to effectively manage a cable where it is required.

### SUMMARY

Mobile, compact, adjustable, position-able, and stable docking systems/apparatus for mobile computing devices may be used to easily interact with a mobile computing device and to manage a cable of the mobile computing device. The docking system may include two housing components. The first housing component may be connected to the second housing component in such a way that the two housing components may be rotated relative to one another.

The first housing component may have a spool affixed. The spool may be operable to reel the cable around itself as the second housing component is rotated relative to the first. The second housing component may have an aperture in a region of its side. The aperture may be sized and/or shaped to receive a cable operable to charge, power, and/or sync a computing device. The aperture of the second housing component may also guide the cable onto the rotating spool.

One of the housing components may include a support stand on a surface opposite an interface between the two housing components. The support stand may include a socket that may hold a mobile-device connector of the cable at an angle determined to position a mobile computing device coupled thereto at a favorable viewing angle. Also, the support stand may be configured to hold a mobile computing device securely, with three points of contact, at the favorable viewing angle, without obstructing the user interface of the computing device.

To allow a user to use a single hand to rotate one of the two housing components relative to the other to reel in or play out the cable, a surface-coupling strip may be affixed to surface of the other housing component opposite the interface between the two housing components. A micro-suction strip, with an array of micro suction cups provides one non-limiting example of such a surface-coupling strip. While being removable and reusable, the surface-coupling strip may affix the other housing component to a surface, holding the other housing surface in place while the first housing component is rotated to manage the cable.

The dock may include a housing connector at a region of overlap between the base and the device stand. The housing connector may be operable to connect the base to the device stand while promoting an ability to rotate the device stand relative to the base. For example, and without limitation, the housing connector may include a rim extending from at least one of the two housing components at the region of overlap between the two housing components. Additionally, the housing connector may include a set of spring-loaded plungers attached to at least one of the two housing components at the overlapping region opposite the rim.

The spring-loaded plungers may be operable to compress upon encountering the rim within the region of overlap as the device stand and the base are pressed together and/or spring outward upon passing the rim to connect the base and the device stand. In such examples, the two housing components may be separated by applying a force to pull the two housing components apart so that the ball bearing may overcome the rim in the opposite direction.

Additionally, the spring-loaded plungers may be selected to manage friction between the device stand and the base during rotation of the device stand relative to the base. For example, and without limitation, the set of spring-loaded plungers may minimize a surface area for an area of contact in the region of overlap. Additionally, or in the alternative, and without limitation, the spring-loaded plungers may be spring-loaded, ball plungers, where the balls are operable to roll along an opposing surface presented at the region of overlap. Alternative approaches to a friction reducing intermediary and/or housing connector may be applied.

In examples where the two housing components are separable, the cable and mobile-device connector may be threaded through a channel in the first housing component to exit the first housing component on the side with the support stand. A cavity shaped and sized to securely hold the mobile-device connector without letting it pass through the first housing component may be recessed into the first housing component to intersect with the channel at an offset angle. The cavity may partially overlap the channel to allow a cord of the cable to continue to pass through the first housing component to the spool attached thereto. The cavity may be excavated from the first housing component with an angle of incline to hold the mobile-device connector at the favorable viewing angle.

The support stand may comprise the surface of the first housing unit and a pair of removable supports separated by a distance predetermined to support a mobile device, of a given thickness, in a cantilevered position, securing the mobile device in place by a camming action. The supports may be short enough not to obstruct the user interface of the mobile computer. Additionally, the distance between the supports may be made adjustable to support different mobile devices, protective cases, and/or other factors that may vary the thickness of the device to be held, so that the support stand may accommodate the device.

In such examples, one or more of the supports may be removable with a tab extending from a base of the support and running along a segment of the length of the support. The tab may be configured to be wedged into a slot in the surface of the first housing component and removed therefrom. Additionally, the tab may be offset such that it is closer to one side of the support than the other. By removing and setting the orientation of the side of the support to which the tab is closest so that it faces toward or away from the opposing support, the distance between the supports may be increased or decreased once the tab is placed in the slot. Where the closest side faces the opposing support the distance between supports may be made greater than when the closest side faces away from the other support, allowing the support stand to accommodate different thicknesses with respect to the mobile device that it holds.

### BRIEF DESCRIPTION OF THE DRAWINGS

In order that the advantages of the disclosures herein will be readily understood, a more particular description will be rendered by reference to specific examples illustrated in the appended drawings. Understanding that these drawings depict only typical examples and are not, therefore, to be considered limiting in scope, the invention will be described and explained with additional specificity and detail through use of the accompanying drawings, in which:

FIG. 1 is a perspective view of examples of a docking system holding computing devices of differing sizes and form factors, in accordance with examples;

FIG. 2 is perspective view of an example dock, which does not hold a mobile computing device, disposed at an angle to show the top configured to hold a mobile computing device, in accordance with examples;

FIG. 3 is an exploded, side view of an example dock, depicting various elements of such a dock, including a support stand, a spool, a cable-receiving aperture, a base, and/or a housing connector operable to rotationally connect the base to other elements, together with a cable for charging, powering, and/or syncing a mobile computing device, the cable being threaded through components of the device, in accordance with examples;

FIG. 4A is a side view of an example dock separated into a device-stand component and a base component, together with a cable pertaining to a mobile computing device threaded through the device stand, in accordance with examples;

FIG. 4B is a side view depicting a cable as it spools around a spool extending from the device-stand component of FIG. 4A as the device stand is rotated relative to the base component, in accordance with examples;

FIG. 4C is an expanded view of a cable reeled around the spool depicted in FIGS. 4A and 4B, in accordance with examples;

FIG. 5A is a side, perspective view of an example dock affixed to a sufficiently smooth surface with a cable threaded through the example dock and a hand grasping the example and prepared to rotate a device-stand component of the example dock relative to a base component, in accordance with examples;

FIG. 5B is a side, perspective view of an example dock affixed to a sufficiently smooth surface with a cable threaded through the example and a hand rotating the device-stand component relative to the base component, which remains stationary, as indicated by the unchanged position of the aperture in the base receiving the cable, relative to its position in FIG. 5A, in accordance with examples;

FIG. 5C is a bottom view of an example dock, showing the micro-suction pads that allow the dock to attach to the smooth surface in FIG. 5A and to remain stationary in FIG. 5B, in accordance with examples;

FIG. 5D is an expanded view of a portion of the array of micro-suction cups carried by one of the example micro-suction pads, in accordance with examples;

FIG. 6A is a cut-away, side view of a portion of an example housing connector involving a spring-loaded plunger housed in an example spool attached to an example device stand, the device stand aligned with a portion of an example base to connect the device stand to the base, in accordance with examples;

FIG. 6B is an expanded view of the example spring-loaded plunger, in accordance with examples;

FIG. 6C is a cut-away, side view of a rim presented by the example base as it compresses the ball of the example spring-loaded plunger in upon its spring, as the spool housing the spring-loaded plunger is dropped into the example base as the example device stand is connected with the base, in accordance with examples;

FIG. 6D is a cut-away, side view of a portion of the example device stand operably connected to a portion of the example base for rotation relative to one and another, the ball of the example spring-loaded plunger being somewhat rebounded and somewhat retracted, such that the ball is operable to roll along a surface presented by the example base, in accordance with examples;

FIG. 7A is a bottom view of an example device-stand component of an example dock with a spool component attached thereto, in accordance with examples;

FIG. 7B is a top view of the device-stand component of the dock with a pair of supports configured to receive and hold a mobile computing device, in accordance with examples;

FIG. 7C is a bottom view of the example device stand depicting a potential first step for threading and securing the cable through and to the device stand, whereby the cable is passed through a channel from the bottom of the device stand out and away from the top of the device stand, the channel sized and shaped to allow passage of a mobile-device connector, in accordance with examples;

FIG. 7D is a top view of the device stand depicting a potential second step for threading and securing the cable through and to the device stand, whereby the mobile-device connector is rotated relative to the orientation imparted to the mobile-device connector by the channel it passed through in FIG. 6C, the rotation effected to align the mobile-device connector with an orientation of a cavity shaped and sized to secure the mobile-device connector, in accordance with examples;

FIG. 7E is a side view of the device stand depicting potential third and fourth steps for threading and securing the cable through and to the device stand, whereby the device connector is inclined, according to a third step, to an angle at which the cavity is recessed into the device stand to provide a favorable angle for viewing the mobile computing device and, according to step four, for inserting the mobile-device connector into the cavity, in accordance with examples;

FIG. 8A is a an exploded, perspective view of one example of the device stand tilted to display one example socket, with an exemplary channel and cavity for threading and securing the cable, in accordance with examples;

FIG. 8B is a side, cut-away view of one example of the device stand displaying various elements of one example socket, with an exemplary channel and cavity for threading and securing the cable, in accordance with examples;

FIG. 9A is a perspective view of exemplary docks with mobile computing devices demonstrating an ability to swivel a direction to which the mobile computing devices face with a single hand, in accordance with examples;

FIG. 9B is a perspective view of a mobile computing device being retrieved from and exemplary dock with a single hand;

FIG. 10A is a side view of an exemplary removable support with a tab configured to wedge in place within an exemplary device stand, in accordance with examples;

FIG. 10B is a top view of an exemplary removable support with a compressibility layer selected to provide some give, or tolerance, with respect to the thickness of the mobile device secured by the support, in accordance with examples;

FIG. 10C is a bottom view of an exemplary, removable support, the tab being centered with respect to the width of the support, in accordance with examples;

FIG. 10D is another bottom view of an exemplary, removable support with the tab offset to one side, allowing the distance between a pair of engaged supports to vary depending on which side of the exemplary, removable support is facing an opposing support in the pair, in accordance with examples;

FIG. 10E is an end view of the exemplary, removable support depicted in FIG. 10C, having the centered tab, in accordance with examples;

FIG. 10F is an end view of the exemplary, removable support depicted in FIG. 10D, having the tab offset to one side, in accordance with examples;

FIG. 10G is a top view of an exemplary device stand with the supports removed to reveal slots configured to receive and to hold the removable supports, in accordance with examples; and

FIG. 11 is a stacked view of multiple, aligned instances of an exemplary device stand for an exemplary dock, the first instance oriented to provide a top view and the second and third instances oriented to provide side views with differing orientations of removable supports to demonstrate the differing distances achievable between the supports depending on support orientation, in accordance with examples.

### DETAILED DESCRIPTION

It will be readily understood that the components of the present invention, as generally described and illustrated in the figures herein, can be arranged and designed in a wide variety of different configurations. Thus, the following more detailed description, as represented in the figures, is not intended to be limiting in the scope, as claimed, but is merely representative of certain examples. The presently described examples will be best understood by reference to the drawings, wherein like parts are designated by like numerals throughout. In some cases, particular instances of an element may be identified with a number followed by a letter, where the letter may change throughout the figures, indicating differing instances of the element with the same or varying attributes. References to elements by number only may refer more generally to a class of such elements.

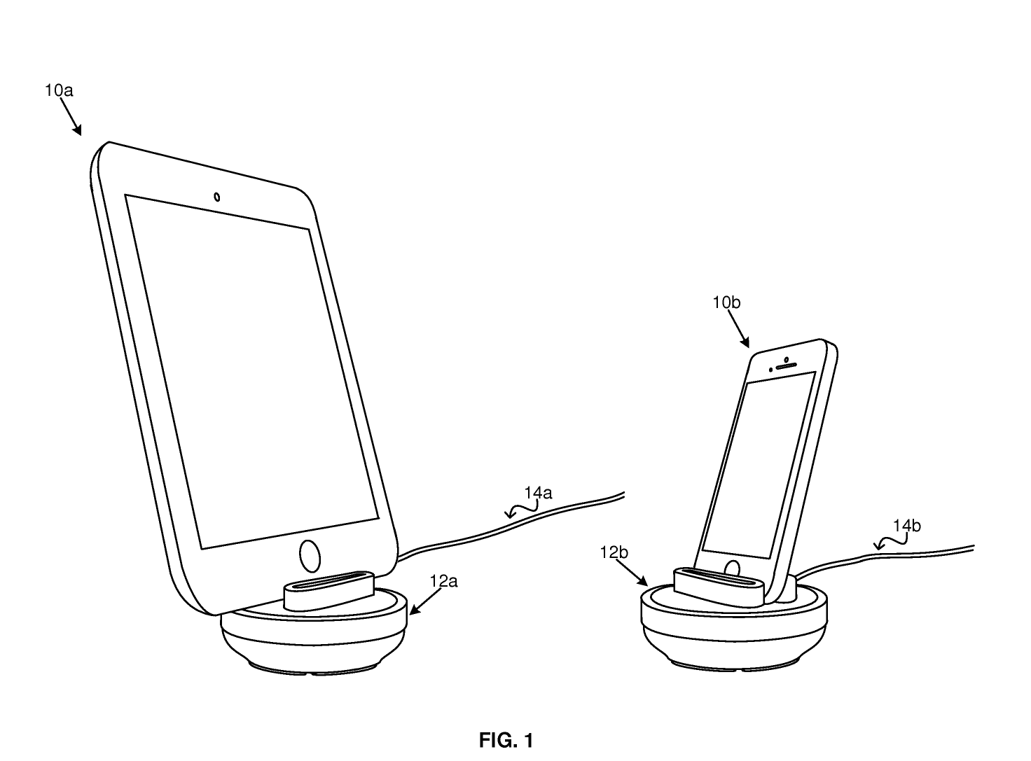

Referring to FIG. 1, two examples of mobile computing devices 10a, 10b are depicted in docks 12a, 12b consistent with examples described herein. Also depicted are examples of cables 14a, 14b leading to the mobile computing devices 10a, 10b and the docks 12a, 12b. The cables may be operable to charge, sync, and/or power the mobile computing devices 10a, 10b.

As depicted by the differing mobile computing devices 10a, 10b, mobile computing devices 10 come in varying form factors, thicknesses, lengths, widths, weights, and/or shapes, among other potential varying attributes. By way of example and not limitation, mobile computing devices 10 may include smart phones, tablets, e-readers, two-in-one devices, portable media players, wearable digital devices, digital cameras, Personal Digital Assistants (PDAs) and/or the like. Often individuals will own multiple mobile computing devise of differing form factors and/or other attributes. Throughout this application, different terms, such as: ‘mobile device,’ ‘mobile computer,’ ‘computing device,’ ‘handheld device,’ and/or the like may be used. Such terms may be used to highlight different aspects of such devices, but are not intended to distinguish between different subjects. Hence any statement made with respect to any one of these terms may be interpreted as applying to other terms used to refer to mobile computing devices 10.

Ideally, a dock system, or dock apparatus 12, may flexibly accommodate mobile computing devices 10 of differing form factors and/or other attributes. Also, as depicted in FIG. 1, a dock 12a, 12b may provide a stand for a mobile computing device 10a, 10b to secure and display the mobile computing device 10a, 10b in such a way that an individual may continue to interact with the device while it is docked. Hence, a user may continue to interact with the mobile computing device 10a, 10b during a daily charging period, while the computing device 10a, 10b is syncing with another computer, and/or while the computing device 10a, 10b is simply powered by its cable 14a, 14b to avoid battery depletion. Additionally, the user may dock the computing device 10a, 10b to free up both hands while continuing to interact with the computing device 10a, 10b. While securing the mobile computing device 10a, 10b and coupling the mobile computing device 10a, 10b with its cable 14a, 14b, the docking system/apparatus 12a, 12b may manage the cable 14a, 14b, as discussed below.

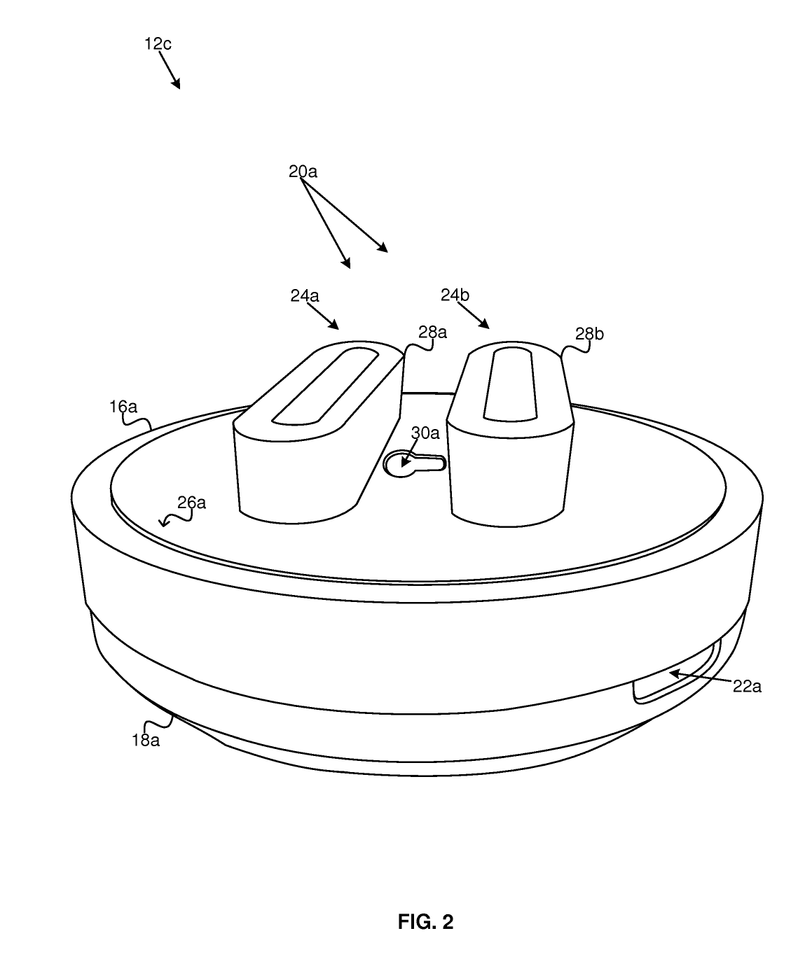

Referring to FIG. 2, an example system/apparatus 12c for docking mobile devices 10 is depicted without a computing device 10 to discuss potential features of such a dock system/apparatus 12c. The docking system/apparatus 12c may include two housing components 16a, 18a. The two housing components 16a, 18a may be rotationally connected together such that the two housing components 16a, 18a may be rotated relative to the on another.

The two hosing components 16a, 18a may include a first housing component 16a, also referred to herein as a device stand 16a. The first housing component 16a may include a confine 20a, also referred to herein as a support stand 20a and/or be a term referring to a portion of the device stand 16a, shaped to hold a mobile device 10 atop the first housing component 16a. The device stand 16a may secure a mobile-device connector, also referred herein as a jack and/or device end, of a cable 14 in the region of the confine 20a for connection to a mobile device 10 during docking.

The second housing component 18a, also referred to herein as a base 18a, or a dish 18a, may be provided with a slot 22a. The slot 22a, also referred to herein as an aperture 22a, may be shaped and/or sized to receive and/or allow passage of a cord pertaining to a cable 14 and attached to a jack for coupling with a mobile computer 10. The slot 22a may span a fraction of a perimeter of the second housing component, thereby guiding the cord as it is received upon a drum, also referred to herein as a reel, and/or a spool, positioned between the two housing components 16a, 18a. The reel may be fixed to one of the two housing components 16a, 18a.

As suggested by the term ‘housing,’ in some examples, the two housing components 16a, 18a may enclose the reel and the cord received by the reel within an enclosure, as is the case in the example depicted in FIG. 2. Such an enclosure may protect the cable 14 and/or help in managing the cable 14 by keeping it out of the way. However, in alternative examples, the housings 16, 18 may leave the reel, the cable 14 and/or a portion of the cable 14 exposed.

As stated, the first housing component 16a, or device stand 16a, may include a confine 20a, or support stand 20a. The confine 20a may include a pair of stays 24a, 24b, also referred to herein as stops 24a, 24b, supports 24a, 24b, and/or, in part, barriers. The support stand 20a may also include a level surface 26a, also referred to herein as a surface plane 26a and/or simply as a surface 26a. The supports 24a, 24b, and/or level surface 26a may be operable to support and/or to hold a mobile device 10 such that a screen of the mobile device is displayed at a predetermined viewing angle and/or within a range of predetermined viewing angles.

In some examples, the supports 24a, 24b may include a compressibility layer 28. A compressibility layer 28 may be made of a material to provide some give, or tolerance when a mobile device 10 is placed in the support stand 20a, to accommodate variations in thickness among mobile devices 10. The compressibility layer 28 may extend along a surface operable to support a mobile device 10 and may compress sufficiently to accommodate a mobile device 10 with an extra degree of thickness while, remaining operable to support, when not compressed, a mobile device 10 without the extra degree of thickness. In addition to the material, the thickness of the compressibility layer 28 may be selected to achieve the desired tolerance.

Additionally, the compressibility layer 28 may provide padding to prevent damage to a computing device 10. Similarly, the level surface 26a may include and/or be made of such padding. As can be appreciated, any number of materials may be used to provide such padding. Without limitation, examples of such materials may include felt, foam, fabric, and/or the like.

The first housing component 16a may also include a socket 30a. The socket 30a may be shaped and/or sized for and securing the cable 14 to the device stand 16a. In some examples, the socket 30a may include a passage for threading the cable 14, and/or a mobile-device connector attached thereto, through the device stand 16a. The socket 30a is discussed in further detail below.

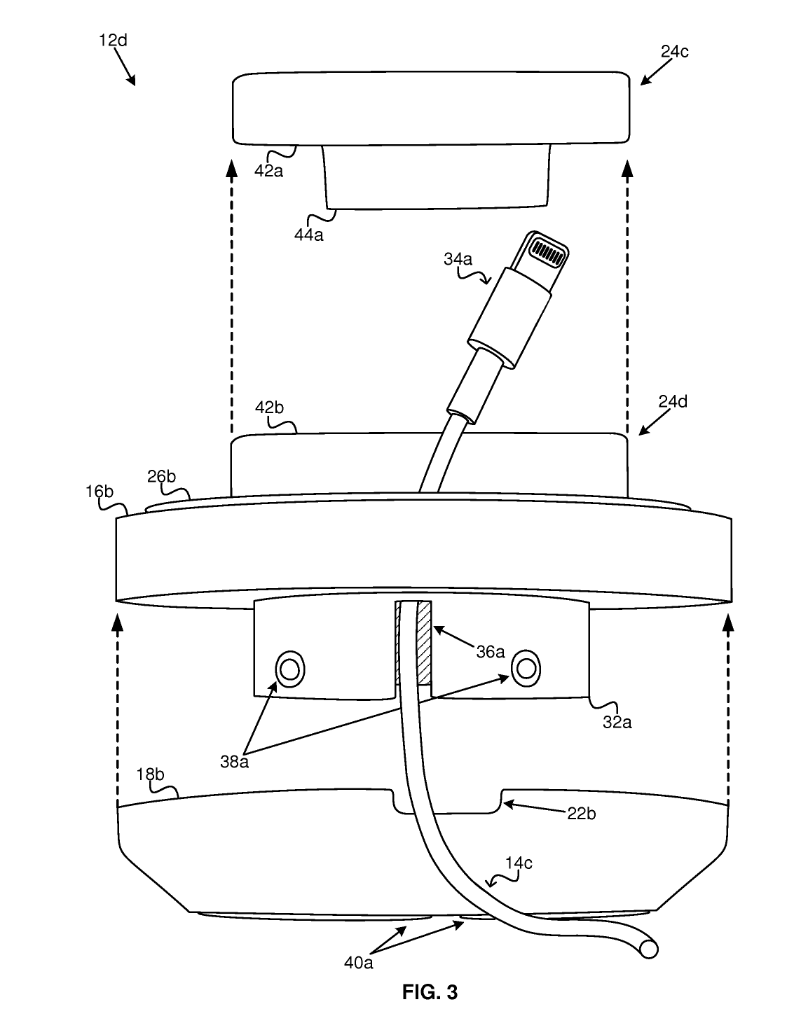

Referring to FIG. 3, a docking system/apparatus 12d is depicted from the side, with various components thereof separated for purposes of explanation and/or discussion and showing a cable 14c for a mobile computer 10 threaded through the system/apparatus 12d. From bottom to top, components may include a base 18b, a device stand 16b, and a support 24c.

The base 18b is depicted with an aperture 22b sized to receive the cable 14c. The cable 14c, which may be operable to at least one of charge, power, and sync a computing device 10, is depicted passing into a region between the base 18b and the device stand 16b above the aperture 22b, indicative of the area through which the cable 14c may be reeled in and/or played out to manage the cable 14c and/or any potential slack therein.

The device stand 16b, as discussed above, may be configured to hold a computing device 10. Affixed to the device stand 16b, a spool 32a, reel 32a, or drum 32a is depicted. The spool 32a may be operable to reel/spool the cable 14c around itself as a user of the docking system 10 rotates the device stand 16a relative to the aperture 22b above the base 18b. Once the device stand 16b and the base 18b are connected together, the device stand 16b may prevent the cable 14c from shifting outside the aperture 22b as the device stand 16b is rotated.

In some examples, the first housing component 16b itself may be viewed as a spool and flange combination 16b the flange extending radially from an end of the spool. In such examples, the second housing component 18b may be viewed as a dish 18b configured to receive the spool with the flange extending atop the dish 18b. For such examples, the support stand 20 configured to support and to secure a mobile computer 10 placed within the support stand 20 may reside atop the end of the spool from which the flange extends. The support stand 20 may include a surface 26b traversing the spool atop the end of the spool from which the flange extends.

Where the spool 32a is also rigidly connected to the device stand 16b so as to rotate when the device stand 16b rotates, the aperture 22b in the base 18b may guide the cable 14c onto the rotating spool 32a. Although the aperture 22b is depicted within the base 18b and the spool 32a is depicted as being affixed to the device stand 16b, this relationship may be switched in some examples. Both scenarios may be used to reel and/or play out the cable 14c on and/or from the spool 32a.

The cable 14c is also depicted as passing through the device stand 16b. The cable 14c and/or a mobile-device connector 34a may be passed through the device stand 16b from the aperture 22b through a passage and/or channel within the socket 30a introduced in the previous figure. In some examples, the two housing components 16b, 18b may be separable, allowing the device end 34a to be threaded from the aperture 22b through the socket 30 from a bottom side and out the top side of the device stand 16b. In some examples, the cable 14c may be threaded this way and then the two housing components 16b, 18b may be sealed together.

The spool 32a may be solid or hollow. Although alternative configurations are possible, the spool 32a may be centered about the socket 30a, and/or the socket 30a may be centered with respect to the device stand 16b. In some examples, the cable 14c may continue from the aperture 22b through a slot 36a in the spool 32a onto a cylindrical surface for reeling the cable 14c.

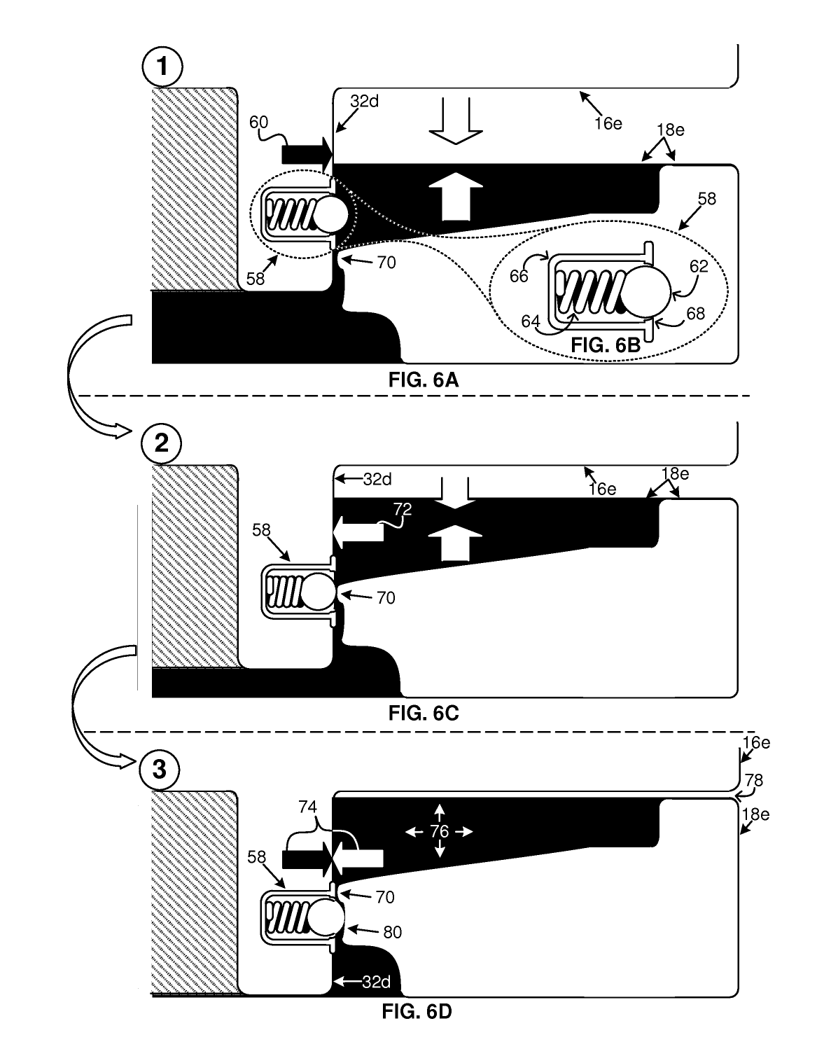

Certain examples may include a housing connector 38a at a region of overlap between the base 18b and the device stand 16b to connect the device stand 16b to the base 18b and/or to facilitate the rotation of the device stand 16b relative to the base 18b. In some examples, such as the example depicted in FIG. 3 and further discussed in FIGS. 6A through 6D, the housing connector 38a may involve a set of spring-loaded plungers operable to engage a lip, or rim, on an opposing housing component, as further discussed below in FIGS. 6A through 6D. However, alternative housing connectors 38, consistent with the disclosures herein are also possible.

For example, a housing connector 38 may involve a set of tabs attached to one of the housing components 16, 18 at a region of concentric overlap between the two housing components 16, 18. The set of tabs may match a set of slots in the roof of a circular track attached to the other housing component in the region of concentric overlap, such that the tabs may be slid past the slots when aligned with the slots to occupy the circular track. Such tabs may be rotated within the circular track to follow the course of the circular track. Furthermore when the tabs are not aligned with the slots, the tabs may prevent extrication from the circular track, thereby rotationally connecting the two housing components 16, 18.

By way of providing another non-limiting example, a housing connector 38 may include a bearing connected to one of the housing components 16, 18 at a region of concentric overlap between the two housing components 16, 18 and a circular track within which or around which the bearing may slide. The track may be attached to the other component in the region of concentric overlap. Either one of the bearing or the track may be elastically expandable to snap around the other, thereby rotationally connecting the two housing components 16, 18 attached to the bearing and the circular track. As can be appreciated, other approaches to providing the housing connector 38, consistent with the disclosures herein, are also possible.

Speaking more generally, the housing connector 38 may include a protrusion and an obstacle. In such examples, the protrusion, which may be plunger of a spring-loaded plunger, a tab, a bearing, and/or the like may be affixed to one of the two housing components 16, 18 at a region of overlapping, concentric cylindrical structures extending from the two housing components 16, 18. Additionally, an obstacle, such as a rim, a circular track with slots, an elastically extendable track, and/or the like may be affixed to the remaining housing component of the two at the region of the overlapping, concentric cylindrical structures. The obstacle may be configured such that the obstacle is encountered by the protrusion as the two housing components 16, 18 are pressed together.

Also, the obstacle may impose one or more conditions upon the protrusion to traverse the obstacle as the housing components 16, 18 are pressed together. Non-limiting examples of such conditions may include the compression of a plunger in a spring-loaded plunger, the matching of tabs with slots in the roof of a circular track, the elastic extension of a bearing or a track, and/or the like. The obstacle may further present the one or more conditions as an obstruction to the protrusion re-traversing the obstacle back in the direction from which it came. In this way, the housing connector 38 may connect the housing component affixed to the protrusion with the housing component affixed to the obstacle. Since the two housing components 16, 18 also present overlapping surfaces, they are also prevented from sliding past each other by being pressed together.

The selection of a housing connector 38 may, in some examples, be guided to reduce friction between the two housing components 16, 18. For example, a housing connector 38 may involve, without limitation and by way example, a set of ball bearings, a track and roller system, a sliding bearing system, a maglev system, and/or the like. As an additional aid to the rotation of the two housing components 16a, 16b relative to one another, the base 18b may have a set of surface-coupling strips 40a affixed thereto. Such surface-coupling strips 40a may couple with a surface to maintain an orientation of the base 18b as the device stand 16b is rotated above.

Exemplary supports 24c, 24d are also depicted from a side view, with a first support 24c removed from the device stand 16b for purposes of discussion, while the second support 24d remains attached to the device stand 16b. The first support 24c demonstrates an ability to be removed. The removable support 24c may include a barrier 42a that rises above the surface plane 26b of the device stand 16b when the support 24c is attached, as demonstrated by the barrier 42b of the second support 24d. The barrier 42a may contribute to the creation of a confine 20b, or support stand 20b, for securing a computing device 10 at a viewing angle. The confine 20b, or support stand 20b, may also include the second barrier 42b and/or the surface plane 26b.

The first support 24c may also include a tab 44a, also referred to herein as a wedge 44a and/or an anchoring protrusion 44a. The tab 44a may extend from a base of the barrier 42a along a portion of a length traversed by the barrier 42. The tab 44a may have less width than the barrier 42a. A slot in the top side of the device stand 16b may receive the tab 42a and wedge the support 24c in place so a distance from the barrier 42a to an opposing barrier 42b of the confine 20 is created to hold and/or secure a computing device 10 at a viewing angle.

The next set of figures are utilized to illustrate the ways in which exemplary docking apparatus/systems 12 may be utilized to provide cable management. To illustrate the effect of a docking system 12 on a cable 14, the two housing components 16, 18 are separated.

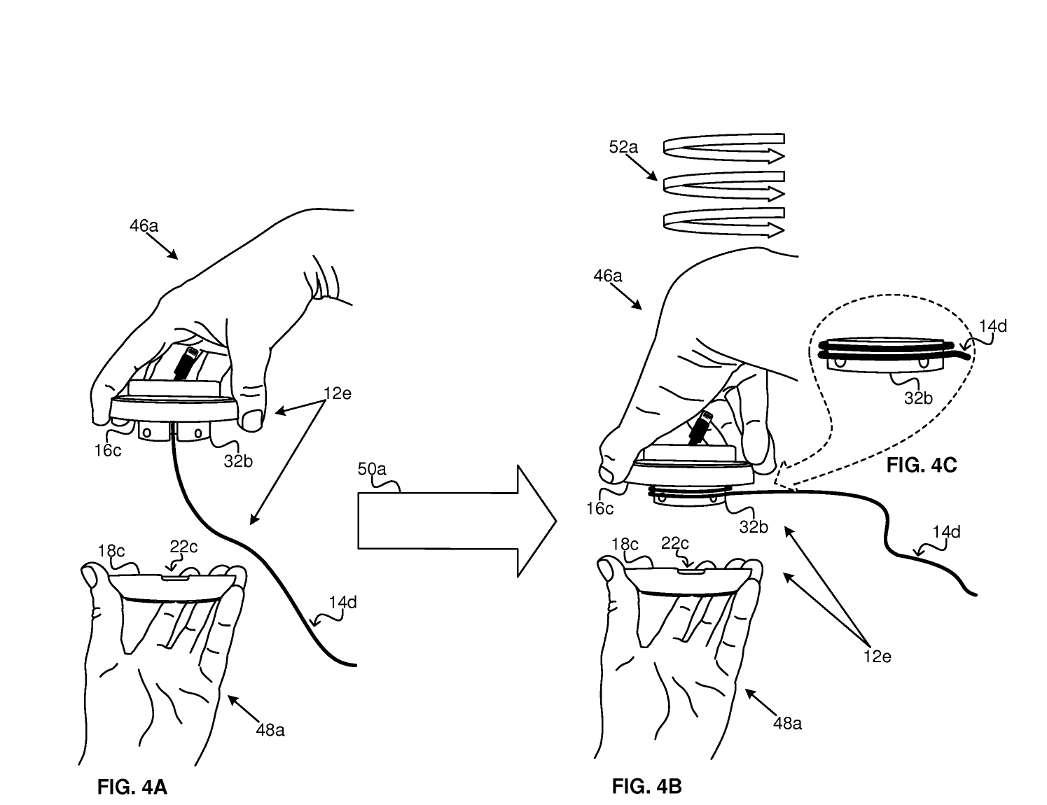

Referring to FIG. 4A, a side view of an exemplary docking apparatus/system 12e is depicted, separated into a device stand 16c and base 18c by a right hand 46a and a left hand 48a. A cable 14d for a mobile computing device 10 is threaded through the device stand 16c in preparation for reeling the cable 14d around a spool 32b. The right hand 46a is prepared to rotate the device stand 16c, while the left hand 48a holds the base 18c in place.

Referring to FIG. 4B, the same exemplary docking apparatus/system 12e depicted in FIG. 4A is depicted from the same side view after a certain amount of time has passed 50a in which the right hand 46a has rotated 52a the device stand 16c. The right hand 46a has rotated 52a the device stand 16c five-hundred and forty degrees, while the left hand 48a has prevented the base 18c from rotating at all, as depicted by the presence of the aperture 22c of the base 18c remaining in the same position between FIGS. 4A and 4B.

As a consequence of the rotation 52a of the device stand 16c, the cable 14d is wrapped one-and-a-half times around the spool 32b attached to the device stand 16c. In this way, potentially troublesome slack in the cable 14d may be remove. As can be appreciated, the device stand 16c can also be rotated in the opposite direction to provide slack once a portion of the cable 14d has been coiled around the spool 32b.

Referring to FIG. 4C, the spool 32b in FIGS. 4A and 4B is depicted in an expanded view. The expanded view further illustrates the way in which the spool 32b reels/spools the cable 14d around itself as the device stand 16c is rotated. In the preceding figures, the depiction of the right hand 46a and the left hand 48a call attention to a need for a force to counter the rotational force applied to the device stand 16c and communicated through friction to the base 18c. Surface-coupling strips, discussed in the following figure, may be applied to provide this counter force.

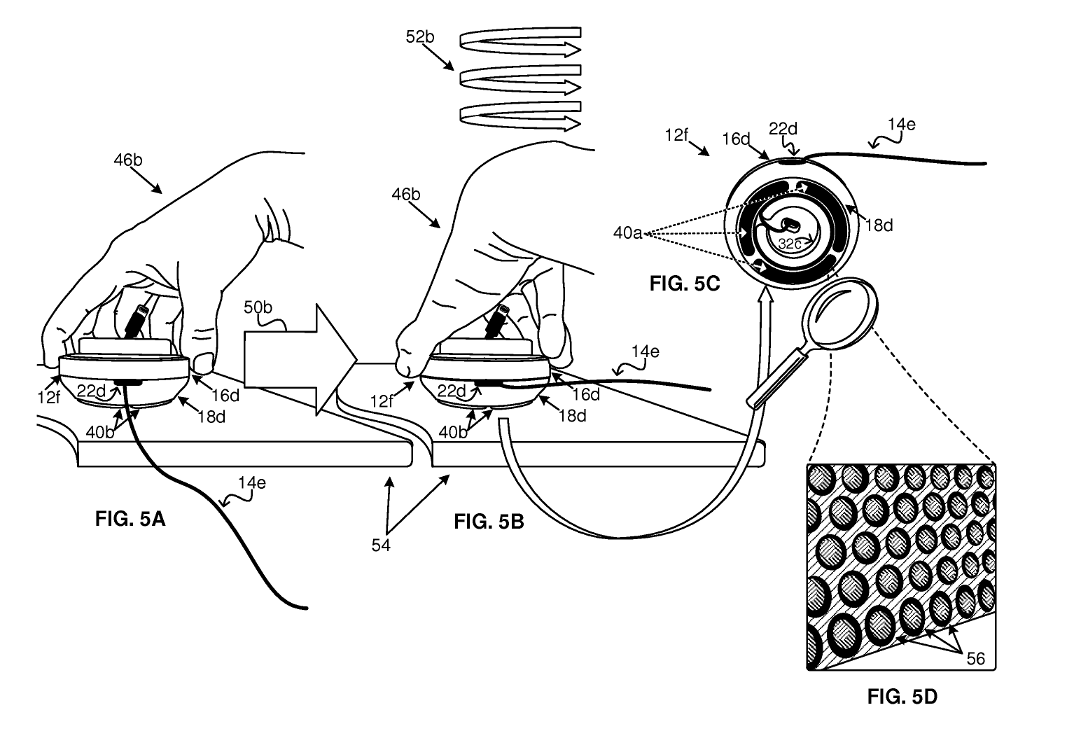

Referring to FIG. 5A, an example dock 12f is depicted. The example dock 12f may include a device stand 16d and a base 18d with an aperture 22d. A cable 14e may be threaded through the aperture 22d and out the top of the device stand 16d.

As depicted in the previous figures, a right hand 46b, which just as easily may be a left hand 48, is depicted. However, contrary to the previous figures, a second hand is not depicted to maintain an orientation of the base 18d when the device stand 16d is rotated by the single hand 46a. The example dock 12f simply sits atop a smooth surface 54.

In the place of a second hand, surface-coupling strips 40b may attach the base 18d to the smooth surface 54, thereby preventing the base 18d from rotating relative to the smooth surface 54. Hence, a single hand 46b may be utilized to rotate the spool 32, reeling the cable 14e around the spool 32 as the device stand 16d is rotated relative to the base 18d. The spool 32 may reel the cable 14e within the first and second housing components 16d, 18d of the dock 12f.

Referring to FIG. 5B, the same dock 12f depicted in FIG. 5A is again depicted after a period of time 50b in which the single hand 46b rotates 52b the device top 16d five-hundred-and-forty degrees relative to the base 18d, which is prevented from rotating by the set of surface-coupling strips 40b, as indicated by the aperture 22d, receiving the cable 14e, maintaining its orientation. In some examples, the base 18d, or dish 18d may be configured to guide the spool 32 as it is turned by external force applied to the spool 32 through the device stand 16d to reel the cable 14e. Furthermore, where the aperture 22d, or opening 22d, of the base 18d, or dish 18d, does not rotate and where the opening 22d is substantially orthogonal to a surface of the spool 32, the opening 22d of the dish 18d may guide the cable 14e onto the rotating spool 32, as depicted in FIGS. 4A to 4C.

Referring to FIG. 5C, the example dock 12f is rotated to present a bottom view, showing the set of surface-coupling strips 40b, attached to the bottom of the base 18d. Also depicted is the spool 32c. The spool 32c may be received and/or guided by the base 18d, which may, in some examples, have a toroidal shape. The cable 14e may extend through a passage out the bottom of the device stand 16d, through a hollow interior of the spool 32 to a slot 36 in the spool 32c and out through the opening 22d, or aperture 22d, provided by the base 18d.

To make the dock 12f as portable as the computing devices 10 it accommodates, the set of surface-coupling strips 40b may be reusable and/or engineered not to leave an adhesive residue behind. Micro-suction tape 40, also referred to herein as a micro-suction pad 40, a micro-suction strip 40, and/or the like, provides one non-limiting example of a technology that may be applied toward these ends. A micro-suction pad 40 may have an adhesive side affixed to a bottom side of the base 18d opposite the device stand 16d residing above the base 18. Also, the micro-suction pad 40 may have a suction-cup side.

Speaking in more general terms, a micro-suction strip 40 may be affixed to a second housing 18 along a surface opposite an interface between the two housing components 16, 18. The micro-suction strip 40 may present an array of micro suction cups with openings facing away from the surface opposite an interface between the two housing components 16, 18. As a result, the micro-suction strip 40 may be used for attaching the two housing components 16, 18 to a sufficiently smooth surface 54. Additionally, the micro-suction strip 40 may be used to allow the first housing component 16 to be rotated relative to the second housing component 18 without rotating the second housing component 18.

Referring to FIG. 5D, an expanded view of a suction-cup side of a micro-suction pad 40 is depicted. The suction-cup side may have an array of micro-suction cups 56 operable to attach the base 18d to a smooth surface 54. Owing to the small size of the suction cups 56, the surface 54 need not be perfectly smooth, as long as enough small areas are presented to allow a sufficient number of suction cups 56 to create a vacuum seal. In other words, the smooth surface 54 may be any surface 54 sufficiently smooth such that the micro-suction tape 40 bound to the bottom side of the dish 18d can allow the micro suction cups 56 to affix the dish 18d to a surface 40 so as to prevent the dish 18d from rotating when the spool 32c is rotated within the dish 18d.

Up until the present point, a connection between the two housing components 16, 18 of the docking apparatus 12 has been presumed to allow the two housing components 16, 18 to rotate relative to one another and, in some examples, be separated and recoupled from one another without an account of how such functionality might be achieved. Further innovations not only provide for such functionalities, but do so in a manner to achieve the overall simplicity and functionality envisioned for the docking apparatus. Such innovations are introduced with the following set of figures.

Referring to FIG. 6A, a cut-away, side view is presented of one, non-limiting approach to providing a housing connector 38, as discussed above with respect to FIG. 3. The approach may involve a spring-loaded plunger 58. The spring-loaded plunger 58 may be housed by a device stand 16e. Furthermore, in some examples, the spring-loaded plunger 58 may be housed in a spool 32d attached to a device stand 16e, as depicted in the cross-sectional view of the portions of the spool 32d and the device stand 16e. In FIGS. 6A through 6C, the cross hatched region represents a portion of the cylindrical enclosure created by some examples of a spool 32d.

Also, in FIGS. 6A through 6C, the black field represents a backside of a base 18e as it wraps around the spool 32d dropping into the base 18e with what, in some examples, is a toroidal shape of the base 18e. The white relief portion of the base 18e represents a portion of a cross section of what, in some, but not necessarily all examples, is a toroidally shaped base 18 sharing a common plane with the cross-section of the portions of the device stand 16e and the spool 32d. As indicated by the vertically facing arrows in FIG. 6A, the aligned device stand 16e and base 18e are being pushed together.

More generally, in examples where the friction reducing intermediary 38 comprises a set of spring-loaded plungers 38, one or more of the set of spring-loaded plungers 38 may be attached to one or more of the two housing components 16, 18 comprising the device stand 16 and the base 18. Such spring-loaded plungers 58 may be attached within an overlapping region between the two housing components 16, 18. A spring-loaded plunger 58 creates an outward force 60 on the plunger.

Where one or both of the two housing components 16, 18 house spring-loaded plungers 58 at a region of overlap, the overlapping region may include cylindrical structures, such as, without limitation, a spool 32d and/or a rim, extending from one or more of the two housing components 16, 18. The set of spring-loaded plungers 58 may be operable to reduce friction when the two housing components 16, 18 are rotated relative to the on another by reducing the size of contacting surface area in the region of overlap. Furthermore, in some examples, the spring-loaded plungers 58 may include balls that may roll on an opposing wall within the region of overlapping cylindrical structures.

Referring to FIG. 6B, an expanded view of one example spring-loaded plunger 58 is presented. An exemplary spring-loaded plunger 58 may include a ball 62 operable to roll across a surface to reduce friction. A spring 64 may be disposed behind the ball 62 within a jacket 66 housing the spring 64 and the ball 62. The spring 64 may generate an outward force 60 on the ball 62, which may be prevented from escaping the jacket by a stop gate 68 extending around the of the ball 62, the annular gap in the stop gate 68 having a radius less than that of the ball 62.

Although spring-loaded plungers 58 with balls 62 may be helpful to reduce friction, some examples may include spring-loaded plungers 58 with a rode in front of a spring 64 where the ball 62 resides in FIG. 6B. As can be appreciated, a variety of plungers 58 may be used, and as discussed above, some housing connectors 38 may be employed that do not rely on plungers. Additionally, in some examples, a platform and sub-balls may be included behind the ball 62 to further increase the ability of the balls 62 to roll.

Referring to FIG. 6C, the cut-away, side view presented in FIG. 6A is depicted at a point in time in which the joining together of the device stand 16 and the base 18e has progressed. A rim 70 element of the base 18e is depicted. In examples where a base 18e is provided with such a rim 70, the rim 70 presented by the base 18e may create an inward force 72 compressing the ball 62 and other balls 62 in the set of ball bearings 38 in upon their corresponding springs 64.

More generally, either and/or both of the two housing components 16, 18 may have a rim 70 compressing the balls 62 inward as the balls 62 encounter the rim 70. The balls 62 may encounter the rim 70 as the two housing components 16, 18 are aligned and pressed together. As discussed in more detail below, the set of spring-loaded plungers 38 may snap the two housing components 16, 18 together as the corresponding springs 64 push the balls 62 outward 72 again after the balls 62 pass the rim 70. In some examples, such as the one depicted in FIG. 6C, as the spool 32d housing the spring-loaded plungers 58 is dropped into the base 18e, as the device stand 16e is connected with the base 18e, balls 62 in the set of ball bearings 38 may encounter a rim 70 presented by the base 18e and be compressed by an inward force 72.

Referring to FIG. 6D, the joining of the device stand 16e and the base 18e has proceeded to a point of completion. The depicted portions of the cross-sections of the device stand 16e and the base 18e are operably connected to one another so that they may be rotated relative to one another. Having passed the rim 70, the ball 62 of the spring-loaded plunger 58 may, at least, somewhat rebound outward. To separate device stand 16e and the base 18e, force would need to be applied to recompress the balls 62 of the set of ball bearings 38 back inward upon their corresponding springs 64 to pass the rim 70 in the opposite direction and separate the device stand 16e and the base 18e. As a result, the device stand 16e and the base 18e remain connected.

Once the device stand 16e and the base 18e are connected, an enclosure 76 may be created. The enclosure 76 may be shaped and/or sized to receive a cable 14 as it is coiled. In the example depicted in FIG. 6D, the enclosure is extracted from the base 18e or dish 18e. In other examples, the enclosure 76 may be extracted from the device stand 16e, or both the base 18e and the device stand 16e.

In some examples, the balls 62 may fully rebound upon passing the rim 70. In other examples, one or more of the balls 62 may remain somewhat retracted, resulting in cancelling inward and outward forces 74, generated by the base 18e and the springs 64 respectively. Hence, the balls 62 may remain partially retracted upon the corresponding springs 64 after snapping together of the two housing components 16, 18 such that the balls 62 may reduce friction by rolling along the opposing surface and/or lifting the device stand 16e above the base 18e.

In such examples, the spring-loaded plungers 38 may present balls 62 in the set of spring-loaded plungers 38 compressed inward upon corresponding springs 64. The balls 62 may reduce friction by, rolling along an opposing surface 80 presented at an overlapping region of the housing components 16, 18. In some, but not all examples, the spring-loaded plungers 38 may create a gap 78 between the two housing components 16, 18 to reduce friction. As can be appreciated, the presence of the opposing surface 80 is not required in some examples.

Underlying the foregoing discussion are assumptions about the ability of a device stand 16 to thread and/or secure a cable 14 and/or a mobile-device connector 34 and to prevent the device connector 34 from rotating relative to the device stand 16. Innovations about how to thread, secure, and/or prevent rotation of the cable 14 and/or the device connector 34, consistent with the goals of improving the functionality and ease of use of a docking system 12 are presented below. The series of views in the following set of figures are used to communicate examples of such innovations.

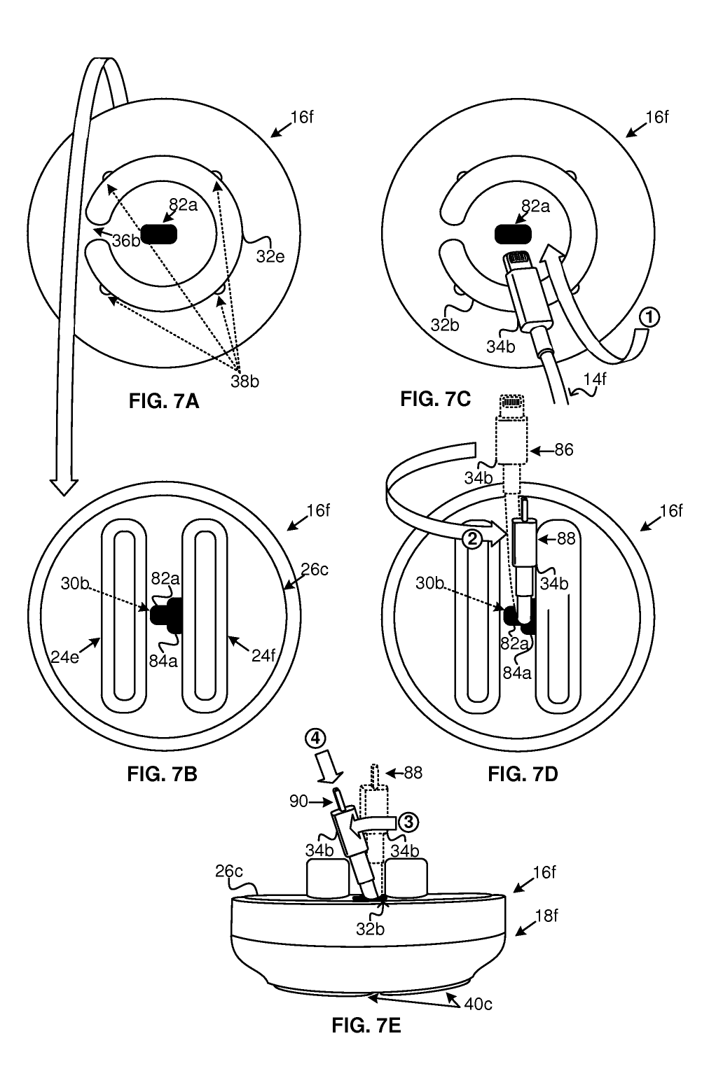

Referring to FIG. 7A, a bottom view of an exemplary device stand 16f is depicted. The device stand 16f depicted is consistent with examples where a spool 32e carrying a set of ball bearings 38b extends downward from the device stand 16f. The spool 32e may enclose a hollow region, which may also include a channel 82a. The channel 82a may be shaped and sized to allow a device end 34 of a cable 14 to pass from the bottom side and out through the top side of the device stand 16f. The spool 32e may also include a slot 36b, allowing the cable 14 to proceed from the channel 82 out to the surface of the spool 32e where it may be reeled in.

Referring to FIG. 7B, the device stand 16e is depicted from the top. The device stand 16e may include a pair of supports 24e, 24f and/or a surface 26c that may combine to create a supporting stand 20 operable to receive and/or secure a computing device 10. The device stand 16e may include a socket 30b. The socket 30b may include the channel 82a discussed above and depicted with a horizontal orientation.

Additionally, the socket 30b may include a cavity 84a, depicted with a vertical orientation. The socket 30b and/or a cavity 84a may hold a device end 34 of a cable 14 protruding through a top side of the device stand 16f. Hence, the socket 30b and/or a cavity 84a may allow the device end 34 to couple with a computing device 10 and/or prevent rotation of the device end 34. In examples where the first housing component 16f itself may be equated with the spool, a cavity 84a, or jacket 84a, may be attached to the spool 16f and accessible from the support stand 20. The jacket 84a may be shaped to secure a mobile-device connector 34 in place. The mobile-device connector 34 may be attached to a cable 14. The jacket 84a may provide an annular passage for the cable 14 out beneath the support stand 20. In such examples, the surface 26e may be punctured by an opening of the jacket 84a.

Referring to FIG. 7C, a potential first step for threading and/or securing a device connector 324b and/or cable 14f is depicted. The device connector 34b of a cable 14f for charging, syncing, and/or powering a mobile computing device 10 is depicted being threaded through the channel 82a from the bottom of the device stand 16f out and away from the top of the device stand 18b. As can be appreciated, the channel 82a may be sized and shaped to allow passage of a device connector 34b.

Referring to FIG. 7D, a potential second step to threading and/or securing a device end 34b is depicted. In the figure, a ghosted image represents a first orientation 86 of the device connector 34b, corresponding to an orientation of the channel 82a through which the device connector 34b passes to the top side of the device stand 16f. An example of a socket 30b including both a channel 82a and cavity 84a is depicted.

The cavity 84a may intersect the channel 82a at a first offset angle. As can be appreciated by the horizontal and vertical orientations of the channel 82a and the cavity 84a respectively, the offset angle depicted in FIGS. 7B and 7D is ninety degrees. However a wide variety of offset angles are also possible.

The cavity 84a may have an opening at the top side of the device stand 16f. The opening and the cavity 84a may have a size and shape able to receive the device end 34b. A matching size and shape of the cavity 84a may prevent rotation of the device end 34b relative to the device stand 16f while the device end 34b is in the cavity 84a.

A potential second step of threading and/or securing the device end 34b may involve rotating the device end 34b to a second orientation 88. The second orientation 88 may coincide with the orientation of the cavity 84a.

Referring to FIG. 7E, potential third and fourth steps for threading and securing a device connector 34b are depicted. The view from the side includes micro-suction strips 40c, a base 18f and the device stand 16f. Picking up where the previous view leaves off, the device connector 34b is depicted as a ghosted image 88 sharing an orientation with the cavity 40c.

A third potential step may include inclining the device connector 34b to a third orientation 90. The third orientation 90 may match an angle of the cavity 84a. The cavity 84a may recede into the device stand 16f at a second offset angle, the angle being from a normal to the level surface 26c, where the top side of the device stand 16f includes a level surface 26c. Since the angle at which the cavity 84a secures the device end 34b may fix the viewing angle of a computing device 10 upon coupling with the computing device 10, the second offset angle may be set to achieve a predetermined viewing angle for the computing device 10.

A fourth potential step may include sliding the device connector 34b, or jack 34b, into the cavity 84a, or niche 84a. The niche 84a may be configured to wedge the jack 34b in place so that a mobile device 10 may be coupled and/or decoupled from the jack 34b with a force applied solely to the mobile device 10. Additionally, the niche 84 may be in the shape of the jack 34 and sized to prevent the jack 34 from rotating relative to the first housing component 16f upon receiving the jack 34.

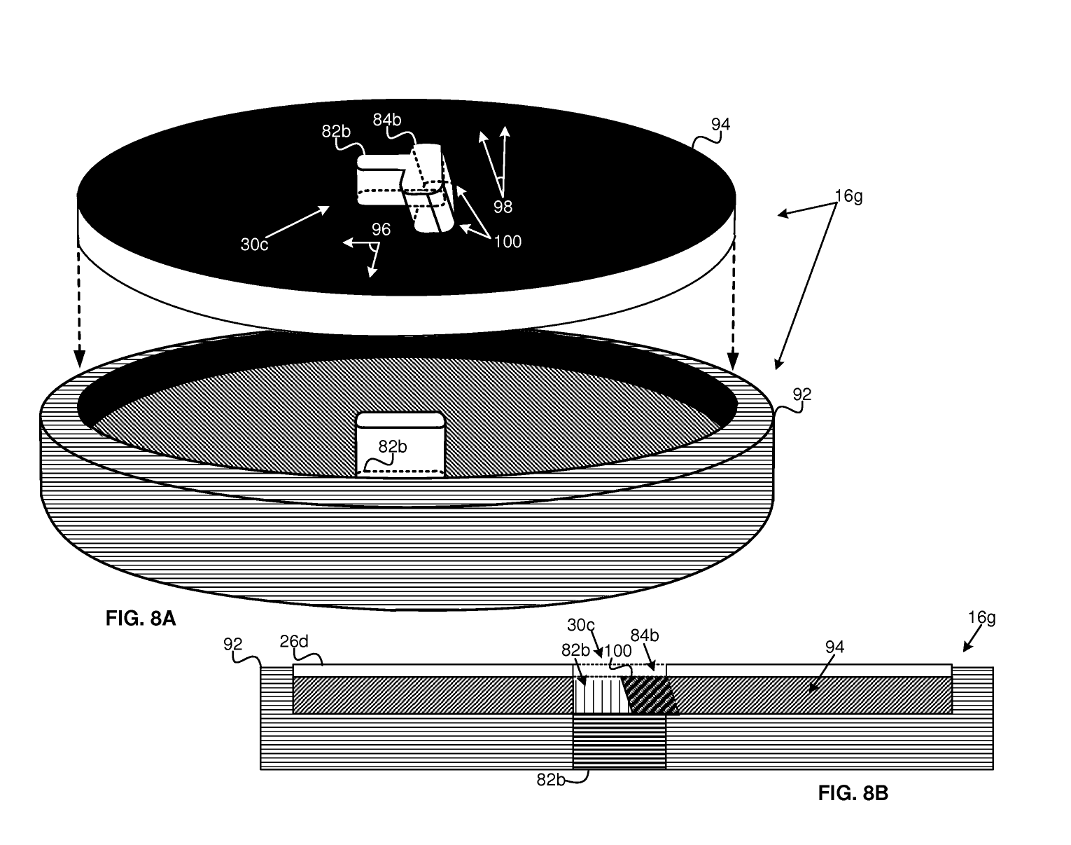

Referring to FIG. 8A, one approach to implementing a socket 30c to thread and secure the device connector 34 of a cable 14 is depicted. A device stand 16g is depicted providing a socket 30c. In some examples, the device stand 16g may include multiple layers. For example, and without limitation, the device stand 16g may be bifurcated into a base layer 92 and an insert layer 94.

In some examples, the material of the base layer 92 may be chosen for aesthetic reasons. For example, but not by way of limitation, a hardwood may be selected for the base layer 92. The channel 82b may be drilled through the base layer 92, but the cavity not be recessed into the base layer 92. However, the base layer 92 may be recessed to receive the insert 94. The insert 94 may be fashioned of the same, or a different material. For example, and not by way of limitation, the insert 94 may be made of a plastic, such as an ABS plastic.

Unlike the base layer 92, the insert 94 may be tooled to include both the channel 82b and the cavity 84. Hence, the channel 82b may result in a clean cut through both the base layer 92 and the insert 94, which may or may not be cut orthogonal to a surface plane 26 of the device stand 16g. The cavity 84b, or niche 84b, may also be cut into the insert 94 with an orientation differing from that of the channel 82b by an offset angle 96, such as, without limitation, ninety degrees.

The cavity 84b may be cut through and/or recessed into the insert 94 at an inclination angle 98 offset from the normal of a surface plane 26 of the device stand 16g to achieve a favorable viewing angle for the device. Also, since the cavity is cut at an offset angle 96 to the channel, there will be one or more lobes 100 of the cavity 84b that do not overlap with the channel 82b, meaning that in the location of these lobes 100 the base layer 92 will block passage through the device stand 16g, keeping the device end 34 from slipping out. Additionally, the cavity 84b may be cut at the offset angle 96 on one end of the channel 82b, resulting, in some examples, in the ‘T’ shape depicted. Therefore, a portion of cavity 84b may overlap with the channel 82, allowing passage of a cord portion of the cable through the device stand 16g. However, the inclination angle and the cavity 82b may cause the backend of the cavity to drift away from the channel 82b, resulting in another region in which the base layer 92 may block passage through the device stand 16g.

Consequently, the combination of the base layer 92 and the insert 94 may result in a first portion of the cavity 84b blocking passage of the device end 34 of the cable 14 from the opening and out through the bottom side. The portion blocking passage may hold the device end 34 so that it protrudes from the top side for coupling with a computing device 10. Also, a second portion may allow a cord portion of the cable 14 attached to the device end 34 to pass from the opening and out through the bottom side of the device stand 16g. Although the insert is depicted with a circular shape in FIG. 8A, as can be appreciated, other shapes are possible. One examples of such an alternative shape may follow a butterfly-like pattern around slots for receiving removable supports 24, thereby preventing rotation of the insert 94.

Referring to FIG. 8B, a side view of a cross section of the layered device stand 16g in the previous figure, including the base layer 92 and the insert 94, is presented. A surface 26d, which may include a padding material, is also depicted. The cross section runs through the center of the socket 30c provided by the device stand 16g, along the length of the channel 82b. The portion of the channel 82b passing through the base layer 92 is depicted with the heavy horizontal cross hatching. The portion of the channel 82b passing solely through the insert layer 99 is depicted with the vertical cross hatching.

A lobe 100 of the cavity 84, blocked by the base layer 92 below, is depicted with the dark diagonal cross hatching. The second portion of the cavity 84b, or niche 84b, may be located along the axis of the channel 82b where the dark horizontal cross hatching sits atop the dark horizontal cross hatching. In this region, an aperture may be extended from the niche 84b through the first housing component 16g. The aperture may be shaped so that a cord extending from a jack 34 can pass through the first housing 16g and further pass through the slot 82b of the second housing 18. The inclination angle 98 of the cavity 84b, however, results in a portion of the cavity 48b drawn back from the channel 82b being blocked by the base layer 92.

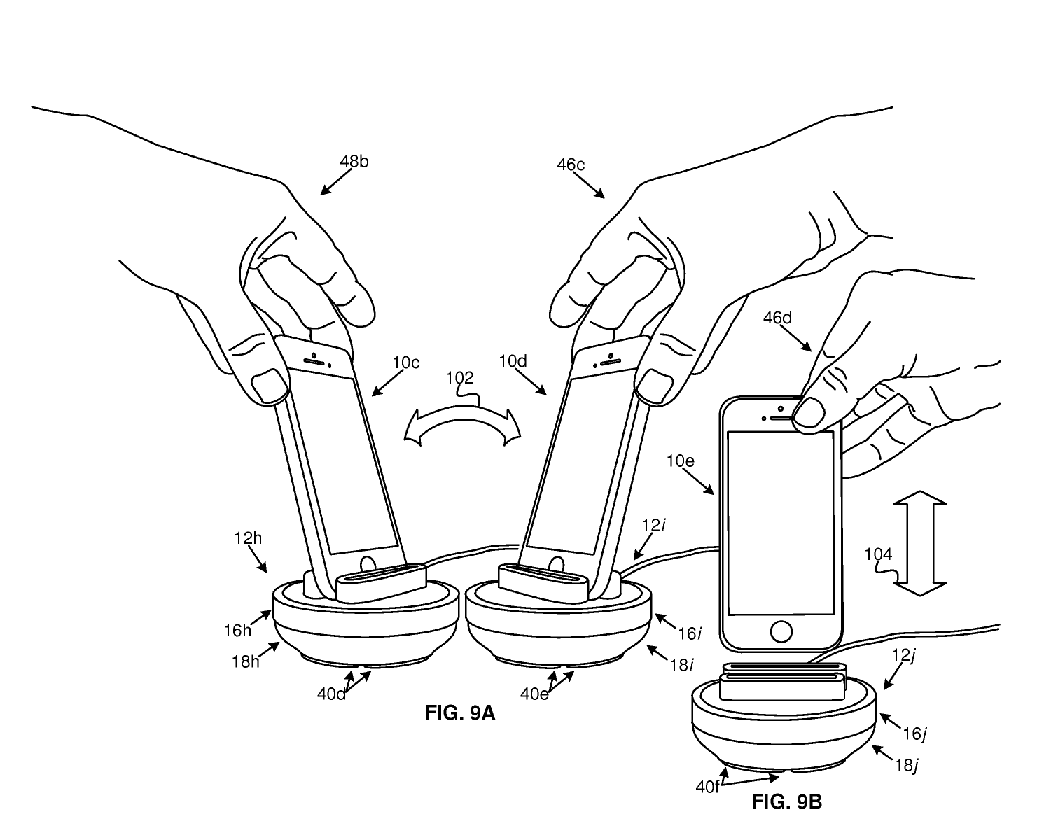

Referring to FIG. 9A, a pair of example docks 12h, 12i are depicted supporting a pair of mobile computing devices 10c, 10d. The ability of the two sets of housing components 16h, 18h, 16i, 18i to be rotated with respect to their partners and the ability of the corresponding surface-coupling strips 40d, 40e to affix corresponding housing components 18h, 18i to a surface 54 may contribute to a setup allowing the computing devices 10c, 10d held atop the device stands 16h, 16i to be swiveled 102 to flexibly redirect the directions the computing devices 10c, 10d face with a single hand 46c, 48b. The use of a friction reducing intermediary 38, such as a set of spring-loaded plungers 38, may be applied to swivel a computing device 10 with a minimal force applied solely to the computing devices 10c, 10d, which may be more easily reached and manipulated than the docks 12h, 12i on which they sit.

Additionally, the pair of supports 24 and/or a surface 26 that may combine to create a supporting stand 20 for a computing device 10 may be employed to provide three points of contact along the length of the supports 24. These three points of contact may be leveraged to provide enhanced stability for a mobile computing device 10. Also, the cantilevered position of a computing device 10 fostered by the supporting stand 20 further secures the computing device 10 when forces are applied to its face during interaction by a camming action. The surface-coupling strips 40d may be leveraged to further enhance stability.

These design enabled stability enhancements may be achieved without getting in the way with user interactions because the profile of the supports 24 may be made not to interfere with the interface, such as a touch screen, of a mobile computing device 10. Also, the added stability may be leveraged to allow a user to continue to interact with a computing device 10 and/or reorient such a dock 12 via forces applied solely to the more accessible and/or reachable computing device 10. To further enhance stability, in some examples, a second housing component 18, or base 18, may be made comprising a high density material. The high density material may have a high density relative to the density of the material of the first housing component 16, or device stand 16.

Additional factors, such as a large form factor for a computing device 10 may call for additional stability. The high density material may provide additional stability to the first housing component 16 to which the high density base 18 is connected to support the mobile device atop 10 the first housing component 16. Additionally, the high density material may contribute to a downward force on the array of micro suction cups 56 acting to engage the micro suction cups 56 on a sufficiently smooth surface. As an added benefit, the high density material may add inertia counteracting a force applied to the mobile device 10 atop the first housing component 16. Such a force may, for example, be applied to swivel 102 the mobile device 10 by rotating the first housing component 16, holding the mobile device 10, relative to the second housing component 18.

Referring to FIG. 9B, another example dock 12j is depicted to demonstrate additional ways in which the foregoing disclosures may be leveraged to improve ease of user interaction with a dock 12. For example, an area of a set of one micro-suction pads 40f may be made sufficiently large to keep the base 18j of the example dock 12j affixed to the smooth surface 54 upon the computing device 10e being decoupled 104 from the device end 34 of a cable 14. In such examples, the computing device 10e may be removed 104 from the device stand 16j by an upward force applied solely to the computing device 10e by a single hand 46d.

Additionally, the snapping action of the set of spring-loaded plungers 38 discussed previously may be leveraged to prevent separation of the two housing components 16j, 18j during such a decoupling motion 104. Conversely, the set of one micro-suction pads 38 may enhance stability and prevent the dock 12j from sliding away when a sheer force is applied during a single-hand coupling 104 of a mobile computing device 10e to a device connector 34 held by the dock 12j.

To provide the advantages discussed above to a wide variety of computing devices 10, the supporting stand 20 may rely on adaptability-providing innovations. Ideally, such innovations may continue to provide high levels of stability. The following figures are used to explain such innovations.

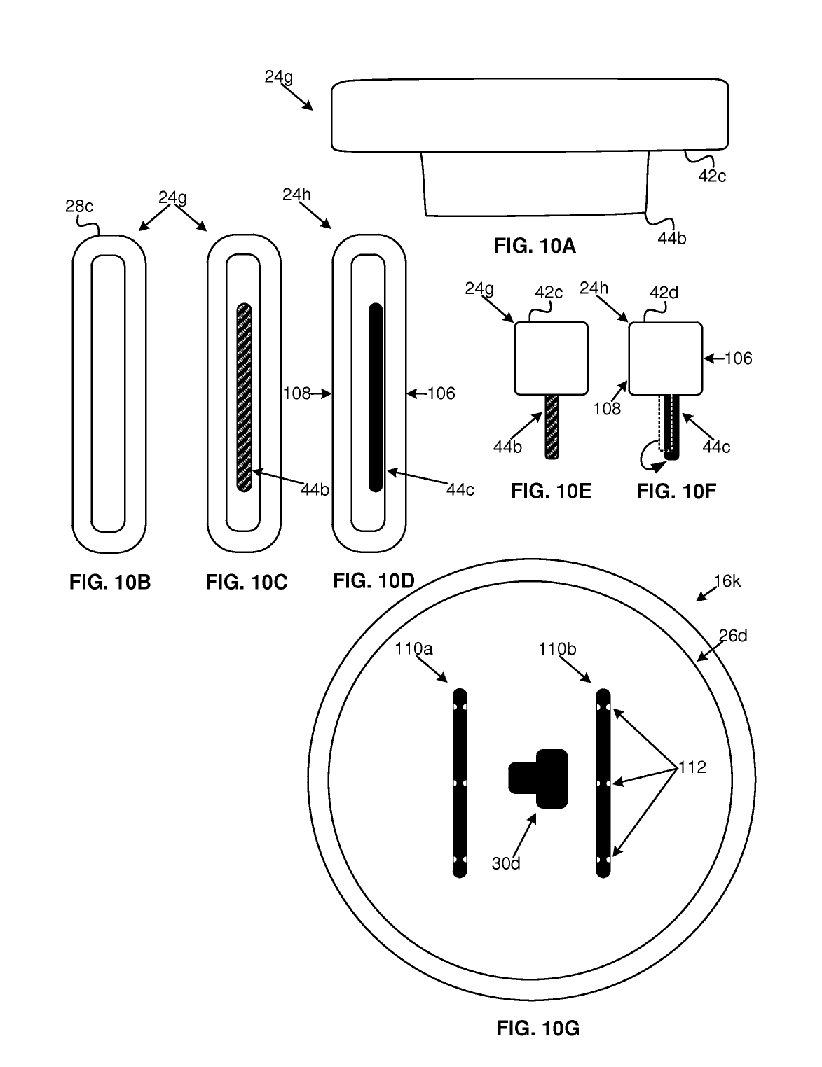

Referring to FIG. 10A, an exemplary removable support 24g, stay 24g, or stop 24g, is depicted from the side, similar to the support 24c in the exploded view of FIG. 3. The stop 24g may include a barrier 42c and a tab 44b, wedge 44b, or anchoring protrusion 44b. The wedge 44b may extend along a segment of the length of the stay 24g. The wedge 44b may be shaped to be wedged into a recess within a surface 26 of the first housing component 16. In some examples, the wedge 44b may be tapered. However, contrary to common usage of the term ‘wedge,’ the wedge 44b need not be tapered.

Referring to FIG. 10B, the stop 24g is depicted from the top. The perimeter of the stop 24g may include a compressibility layer 28c. The compressibility layer 28c may be selected, in terms of material and/or thickness, to provide some give, or tolerance, with respect to a thickness of a mobile device 10. For example, a mobile device 10 may have a thickness that is somewhat greater than a distance between a pair of supports 24 may provide for to achieve a desired viewing angle, or viewing angle within a selected range of viewing angles, especially when the mobile device 10 is coupled with the mobile device connector 34, where the supports 24 are made of a stiff, rigid material. However, the compressibility layer 28c may compress more than it otherwise would have, providing the give, or tolerance for an acceptable viewing angle and/or allowing the mobile device 10 to couple with the mobile connector 34.

Conversely, when the mobile devices 10 is somewhat thinner than anticipated, the compressibility layer 28c might compress somewhat less than it might otherwise would have done, while maintaining contact with the mobile device 10 and continuing to provide a level of support. Additionally, or in the alternative, the compressibility layer 28c may serve to pad, or protect the mobile device 10 from scratching. As discussed above, felt may provide one non-limiting example of one material capable of providing such give, tolerance, padding, and/or protection.

Referring to FIG. 10C, a bottom view of the stop 24g is depicted. The tab 44b, depicted by the diagonal cross hatching, may have a width and/or a length shorter than a width or length of the support 24g. In the example depicted in FIG. 10c, the tab 44b may be centered with respect to the stop 24g. However, in other examples, one or more tabs 44 from a pair of stays 24 may be offset to one side of the stay 42b with respect to the width of the one or more stays 24.

Referring to FIG. 10D, a bottom view of another stay 24h is depicted. In this new example of a potential stay 24h, the tab 44c, also having a lesser width than that of the support 24h, may be offset such that the tab 24h is closer to a first side 106 relative to a second side 108 of the barrier 42 along the length of the support 24h.

Referring to FIG. 10D and FIG. 10E, end views are provided of the two stays depicted in FIG. 10C and FIG. 10D, stay 24g and stay 24h, respectively. As in FIG. 10C, the wedge 44b, also presented with diagonal cross hatching, of stay 24g is centered relative to the barrier 42c to which it is attached in the end view provided by FIG. 10E. Conversely, the wedge 44c, also presented with the solid black fill, of the second stay 24h is offset relative to the barrier 42d to which it is attached in the end view provided by FIG. 10F. As can be appreciated from the end view in FIG. 10F, the wedge 44b may run along the length of the stay 24h closer to a first side 106 of the stay relative to an opposite side 108. To highlight this offset, a ghosted image of the position the wedge 44c would occupy if centered is depicted alongside the offset wedge 44c, with the offset indicated by the arrow.

Referring to FIG. 10G, a top view of a device stand 16k is depicted. The surface 26d may further include grooves 110a, 110b, or slots 110a, 110b, configured to receive an anchoring protrusion 44, or tab 44, of a stop 42 from the pair of stops 42g, 42h. The groves 110a, 110b may be situated on either side of a socket 30d. In some examples, the slots 110a, 110b, may include a set of nobs 112 or protrusions 112 to wedge the tabs in place. For certain of such examples, the slots 110a, 110b and/or nobs 112 may be cut into the insert 94 discussed previously.

The offset of a tab 44c discussed with respect to FIG. 10d and FIG. 10F may be leveraged to introduce adaptability into the supporting stand 20 for computing devices 10. Such adaptability is discussed with the aid of the following figure.

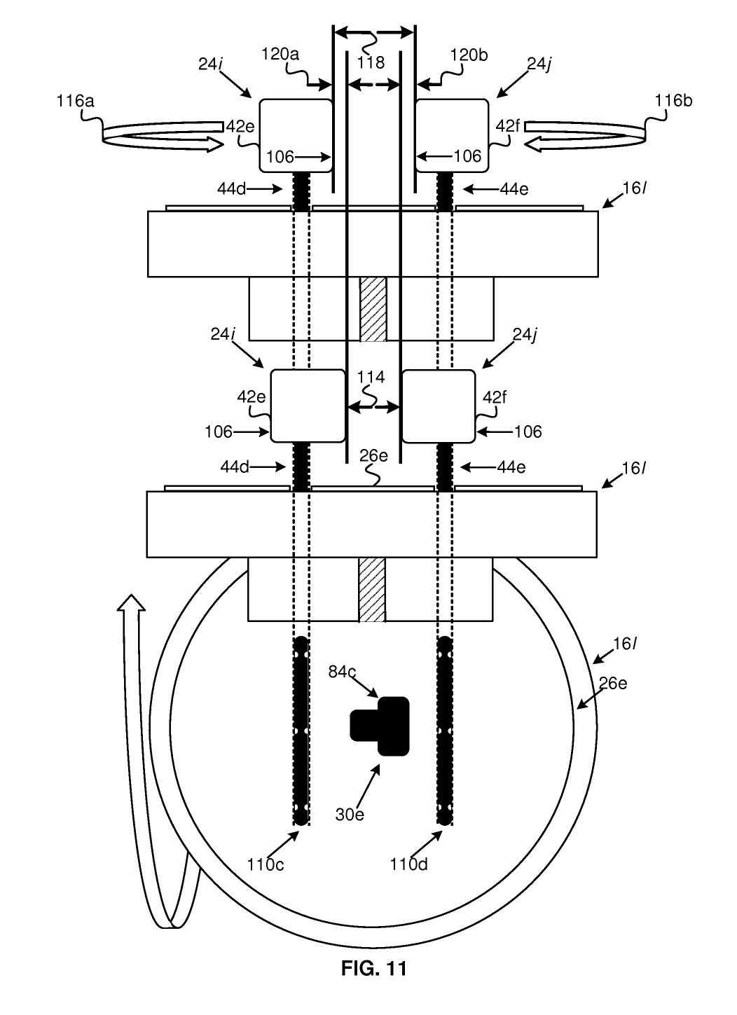

Referring to FIG. 11, multiple, aligned and stacked instances of an exemplary device stand 16l are depicted. At the bottom of the figure, a top view of the device stand 16l is depicted. Two slots 110c, 110d operable to receive tabs 44 from stops 24 are depicted in a vertical alignment together with a surface plane 26e of the device stand 16l. The slots 110c, 110d may be arranged on either side of a socket 30e, which may include a niche 84b. Above the top view, the device stand 16l is rotated ninety degrees, while maintaining its central alignment with the top view, to present a first side view of the device stand 16l.

To show the alignment of the various views of the device stand 16l, dotted lines along the lengths of the slots 110c, 110d in the first view are extended upward, indicating the location of these slots 110c, 110d in the two rotated views above. The side view of the device stand 16l is depicted with a pair of stops 24i, 24j rising from the surface 26e. The stops 24i, 24j may include barriers 42e, 42f atop wedges 44d, 44e respectively. The stops 24i, 24j may be separated by a distance 114. Although the stops 24i, 24j are depicted with their tabs 44d, 44e only partially dropped in the corresponding slots 110c, 110d for purposes of explanation, when the tabs 44d, 44e are fully dropped in their corresponding slots 110c, 110d, the stops 24i, 24j and the surface plane 26e may make up a supporting stand 20 for a computer device 10.

With respect to such a supporting stand 20, the distance 114 between the stops 24i, 24j may be predetermined to support a mobile computer 10 of a given thickness in a cantilevered position. The cantilevered position may tilt a screen on a front side of the mobile computer 10 at a predetermined angle for viewing.

One of the stops 24 from the pair of stops 24i, 24j may provide a rest for a back side of the mobile computer 10. A bottom edge of the mobile computer 10 may rest atop the surface 26e between the pair of stops 24i, 24j. The first stop may further provide an axis of rotation for the mobile device 10 as it is inclined in its cantilevered position.

A second stop 24 from the pair of stops 24i, 24j may provide a torque sufficient to prevent the mobile computer 10 from rotating around the axis of rotation and/or to secure the mobile computer 10 by counteracting a rotational force acting on the mobile computer 10 in the a cantilevered position. Additionally, or in the alternative, the second stop 24 may provide an impediment preventing the bottom edge of the computing device 10 resting on the surface 26e from sliding away from the first stop 24.

As with the support 24h depicted in FIG. 10D and FIG. 10F, the pair of stops 24i, 24j depicted in FIG. 11 each have an anchoring protrusion 44d, 44e, or tab 44d, 44e, offset from a base of the stop 24i, 24j so that the tab 44d, 44e is closer to a first side 106 of the stop 24i, 24j relative to an opposing side. In the first side view from bottom, the stops 24i, 24j are oriented such that the tabs 44d, 44e are dropped into the slots 110c, 110d so that the first side 106 on both stops 24i, 24j face away from one another, resulting in a first distance 114 between the two 24i, 24j. Conversely, in the first side view from top, the stops 24i, 24j are each flipped 116a, 116b one-hundred-and-eighty degrees relative their previous orientation in the bottom side view, giving them a new orientation. In the new orientation, the tabs 44d, 44e are dropped into the slots 110c, 110d so that the first side 106 on both stops 24i, 24j face each other, resulting in a second distance 118 between the two 24i, 24j.

Depending on the example, the first side 106 of the stops 24i, 24j may both face away from each other, toward each other, or one may face toward the other stop 24 and the other may face away. The orientation of each stop 24i, 24j may add or subtract a contribution 120a, 120b to or away from the overall distance between the two stops 24i, 24j. A relatively increased distance may result when the tab 44 is wedged in the slot 110 such that the first side 106 of the support 24 is closer to the opposing support 24. On the other hand, a relatively decreased distance may result when the tab 44 is wedged in the slot 110 such that the second side, opposite the first side 106, of the support 24 is closer to the opposing support 24.

Stated another way, a distance between a stay 24 from the pair of stays 24i, 24j and the other stay 24 from the pair of stays 24i, 24j may be longer where the wedge 44 is wedged into a recess 110 with the first side 106 of the stay 24 closer than the opposite side 108 to the other stay 24. In such examples, the position of the first side 106 of the stop 24 will be at a first distance from the opening of the jacket 84c when the first side 106 of the stop 24 faces the opening. Reflexively, the distance may be shorter where the wedge 44 is wedged into the recess 110 with the opposite side 108 of the stay closer than the first side 106 to the other stay 24. In such examples, the position of the first side 106 of the stop 24 will be at a second distance, different from the first distance, from the opening of the jacket 84c when the first side of the stop faces 106 away from the opening.

In some examples, the shorter distance 114 associated with the bottom side view may correspond to a distance at which the pair of stays 24i, 24j hold a mobile device 10 such that a screen of the mobile device 10 is displayed within the range of predetermined viewing angles. Alternatively, the longer distance 116 may correspond to a distance at which the pair of stays 24i, 24j hold the mobile device 10 enclosed within a case, such as a protective case, such that a screen of the mobile device may also be displayed within the range of predetermined viewing angles.

Also, in some examples, the first distance 112 and/or the second distance 116 may be set to contribute to a set of overall distances between the pair of stops 24i, 24j comprising distances that hold a mobile computer 10 at the predetermined angle for different thicknesses of the mobile computer 10. Various reasons may result in different thicknesses. By way of example, and not limitation, different thicknesses may arise simply because different mobile computers may have differing thicknesses. The absence or presence of a protective case may result differing thicknesses. The use of a first protective case as opposed to the use of a second protective case with a differing thickness also provides another non-limiting factor.

The present disclosures may be embodied in other specific forms without departing from their spirit or essential characteristics. The described examples are to be considered in all respects only as illustrative, not restrictive. The scope of the invention is, therefore, indicated by the appended claims, rather than by the foregoing description. All changes within the meaning and range of equivalency of the claims are to be embraced within their scope.

1. A docking system for a computing device comprising:
two housing components comprising a device stand and a base, the two housing components rotationally connected one to another;
one of the base and the device stand having an aperture sized to receive a cable, the cable operable to at least one of charge, power, and sync a computing device;
the device stand configured to hold the computing device and to be rotated above the base, the device stand with a socket configured to:
pass the cable through the device stand; and
hold a device end of the cable protruding through a top side of the device stand, allowing the device end to couple with the computing device and preventing rotation of the device end; and
a spool affixed to one of the two housing components not having the aperture, the spool operable to reel the cable around itself as the device stand is rotated above the base.

2. The system of claim 1, further comprising a housing connector at a region of overlap between the base and the device stand, the housing connector operable to connect the base to the device stand while promoting an ability to rotate the device stand relative to the base.

3. The system of claim 2, further comprising at least one micro-suction pad, having an array of micro-suction cups affixed to a bottom of the base and operable to attach the base to a smooth surface, thereby preventing the base from rotating relative to the smooth surface, the spool reeling the cable around the spool as the device stand is rotated relative to the base.

4. The system of claim 3, wherein an area of the at least one micro-suction pad is sufficiently large to keep the base affixed to the smooth surface upon the computing device being decoupled from the device end of the cable and the computing device being removed from the device stand by an upward force applied solely to the computing device

5. The system of claim 2, wherein the housing connector comprises:
a rim extending from at least one of the two housing components at a region of overlap between the two housing components; and
a set of spring-loaded plungers attached to at least one of the two housing components at the region of overlap and opposite the rim, the set of spring-loaded plungers operable to:
compress upon encountering the rim within the region of overlap as the devices stand and the base are pressed together;
spring outward upon passing the rim to connect the base and the device stand; and
manage friction between the device stand and the base during rotation of the device stand relative to the base by at least one of:
minimizing contact surface area in the region of overlap; and
presenting balls in the set of spring-loaded plungers operable to roll along an opposing surface presented at the region of overlap.

6. The system of claim 5, wherein the two housing components are separable, the set of spring-loaded plungers operable to overcome the rim in the opposite direction with application of force to pull the two housing components apart, allowing the device end to be threaded from the aperture and through the socket from a bottom side and out the top side of the device stand.

7. The system of claim 1, wherein the socket further comprises:
a channel shaped and sized to allow the device end of the cable to pass from a bottom side and out through the top side of the device stand; and
a cavity that intersects the channel at a first offset angle, the cavity having an opening at the top side, the opening and the cavity having a size and shape able to receive the device end and prevent rotation of the device end relative to the device stand while the device end is in the cavity, the cavity having:
a first portion blocking passage of the device end of the cable from the opening and out through the bottom side, such that the first portion blocking passage holds the device end protruding from the top side for coupling with the computing device; and
a second portion allowing a cord portion of the cable attached to the device end to pass from the opening and out through the bottom side of the device stand.

8. The system of claim 7, wherein:
the top side of the device stand comprises a level surface; and
the cavity recedes into the device stand at a second offset angle from a normal to the level surface, achieving a predetermined viewing angle for the computing device, the device end fixing the viewing angle upon coupling with the computing device.

9. The system of claim 1, wherein the device stand comprises:
a removable support comprising:
a barrier rising above a surface plane of the device stand, the barrier configured to contribute to a confine securing the computing device at a viewing angle; and
a tab, with less width than the barrier, extending from a base of the barrier along a portion of a length traversed by the barrier, the tab offset such that the tab is closer to a first side relative to a second side of the barrier along the length; and
a slot in the top side of the device stand receiving the tab and wedging the support in place so a distance from the support to an opposing support of the confine is one of:
a relatively increased distance when the tab is wedged in the slot such that the first side of the support bar is closer to the opposing support; and
a relatively decreased distance when the tab is wedged in the slot such that the second side of the support bar is closer to the opposing support.

10. An apparatus for docking mobile devices comprising:
two housing components connected together such that the two housing components may be rotated relative to one another, the two hosing components comprising:
a first housing component with a confine configured to hold a mobile device atop the first housing component and to secure a jack for connection to the mobile device during docking;
a second housing below the first housing component;
a slot spanning a fraction of a perimeter of one of the two housing components, the slot able to receive a cord attached to the jack; and
a reel between the two housing components, fixed to one of the two housing components, and operable to reel a cord connected to the jack within a region between the two housing components as the two housing components are rotated relative to one another.

11. The apparatus of claim 10, the first housing component further comprising:
a niche in a shape of the jack and sized to:
receive the jack;
prevent the jack from rotating relative to the first housing component; and
wedge the jack in place so that a mobile device may be at least one of coupled and decoupled from the jack with a force applied solely to the mobile device; and
an aperture extending from the niche through the first housing component and shaped so that a cord extending from the jack can pass through the first housing component.

12. The apparatus of claim 10, further comprising:
a protrusion affixed to one housing component of the two housing components at a region of overlapping, concentric, cylindrical structures extending from the two housing components,
an obstacle affixed to a remaining housing component of the two housing components at the region of overlapping, concentric cylindrical structures, wherein the obstacle:
is encountered by the protrusion as the two housing components are pressed together;
imposes at least one condition upon the protrusion to traverse the obstacle as the housing components are pressed together; and
presents the at least one condition as an obstruction to the protrusion re-traversing the obstacle back in the direction from which it came, connecting the housing component affixed to the protrusion with the housing component affixed to the obstacle; the two housing components presenting overlapping surfaces preventing the two housing components from sliding past each other by being pressed together.

13. The system of claim 12, further comprising a micro-suction strip affixed to the second housing component along a surface opposite an interface between the two housing components, the micro-suction strip presenting an array of micro suction cups with openings facing away from the surface opposite the interface between the two housing components, thereby:
attaching the two housing components to a sufficiently smooth surface; and
allowing the first housing component to be rotated relative to the second housing component without destabilizing the second housing component.

14. The system of claim 13, the second housing component comprising a high density material with a high density relative to at least one low density material of the first housing component, the high density material providing at least one of:
stability to the first housing component to support the mobile device atop the first housing component; and
a downward force on the array of micro suction cups, acting to engage the micro suction cups on a sufficiently smooth surface; and
inertia counteracting a force applied to the mobile device atop the first housing component, the force applied to swivel the mobile device by rotating the first housing component holding the mobile device.

15. The apparatus of claim 10, the apparatus further comprising:
a pair of stays operable to support and to hold the mobile device such that a screen of the mobile device is displayed within a range of predetermined viewing angles;
a wedge extending along a segment of a length of a stay from the pair of stays, the wedge shaped to be wedged into a recess within a surface of the first housing component, the wedge running along the length of the stay closer to a first side of the stay relative to an opposite side of the stay such that a distance between the stay and the other stay from the pair of stays is:
longer where the wedge is wedged into the recess with the first side of the stay closer than the opposite side to the other stay; and
shorter where the wedge is wedged into the recess with the opposite side of the stay closer than the first side to the other stay.

16. The apparatus of claim 15, wherein the stay further comprises a compressibility layer along a surface operable to support a mobile device, the compressibility layer comprising at least one of a material and a thickness selected to compress sufficiently to accommodate a mobile device with an extra degree of thickness while remaining operable to support a mobile device without the extra degree of thickness.

17. A docking system, the system comprising:
a spool configured to reel a cable bellow a flange extending radially from an end of the spool;
a dish configured to receive the spool with the flange extending atop the dish, the dish configured to guide the spool as it is turned by external force applied to the spool to reel the cable, the dish having an opening substantially orthogonal to a surface of the spool, the opening guiding the cable onto the rotating spool; and
micro-suction tape bound to a bottom side of the dish with micro suction cups capable of affixing the dish to a surface, preventing the dish from rotating when the spool is rotated within the dish.

18. The system of claim 17 further comprising:
a support stand atop the end of the spool from which the flange extends, the support stand configured to support and to secure a mobile computer placed within the support stand; and
a jacket attached to the spool and accessible from the support stand the jacket shaped to secure a mobile-device connector in place, the mobile-device connector attached to the cable and the jacket provided with an annular passage for the cable out beneath the support stand, the cable continuing through a slot in the spool onto a cylindrical surface for reeling the cable.

19. The system of claim 18, the support stand comprising:
a surface traversing the spool atop the end of the spool from which the flange extends, the surface punctured by an opening of the jacket; and
a pair of stops rising from the surface and separated by a distance predetermined to support the mobile computer, of a given thickness, in a cantilevered position that tilts a screen on a front side of the mobile computer at a predetermined angle for viewing:
a first stop from the pair of stops providing a rest for a back side of the mobile computer, a bottom edge of the mobile computer resting atop the surface between the pair of stops, the first stop further providing an axis of rotation for the mobile device; and
a second stop from the pair of stops providing at least one of:
a torque sufficient to prevent the mobile computer from rotating around the axis of rotation and to secure the mobile computer by counteracting a rotational force acting on the mobile computer in the a cantilevered position; and
an impediment preventing the bottom edge from sliding away from the first stop.

20. The system of claim 19, wherein:
the surface further comprises a groove configured to receive an anchoring protrusion of a stop from the pair of stops, the anchoring protrusion offset from a base of the stop so as to:
position a first side of the stop at a first distance from the opening of the jacket when the first side of the stop faces the opening; and
position the first side at a second distance, different from the first distance, from the opening when the first side faces away from the opening,
the first distance and the second distance set to contribute to a set of overall distances between the pair of stops comprising distances that hold the mobile computer at the predetermined angle for different thicknesses of the mobile computer arising from at least one of:
mobile computers of differing thicknesses;
an absence of a first protective case;
the presence of the protective case;
and the presence of a second protective case resulting in a different thickness relative to the presence of the first protective case.
